(19) United States
(12) Patent Application Publication
(10) Pub. No.: US 2026/0125549 A1
(43) Pub. Date: May 7, 2026

(54) TRANSPARENT FLAME-RETARDANT SHEET HAVING HIGH CHLORINE CONTENT AND POLYVINYL CHLORIDE COMPOSITION THEREOF

(71) Applicant: NAN YA PLASTICS CORPORATION, TAIPEI (TW)

(72) Inventors: CHING-YAO YUAN, TAIPEI (TW); CHUN-CHE TSAO, TAIPEI (TW); Ci-Syuan Liou, TAIPEI (TW)

(21) Appl. No.: 19/004,467

(22) Filed: Dec. 30, 2024

(30) Foreign Application Priority Data
Nov. 7, 2024 (TW) 113142659

(51) Int. Cl. C08L 27/24; C08J 5/18; C08K 3/22; C08K 5/00; C08K 5/098; C08K 5/521; C08K 13/02

(52) U.S. Cl. CPC C08L 27/24; C08J 5/18; C08K 13/02; C08J 2327/24; C08J 2427/06; C08J 2433/04; C08K 2003/2296; C08K 5/0091; C08K 5/098; C08K 5/521; C08K 2201/014; C08L 2201/02; C08L 2201/08; C08L 2201/10; C08L 2205/025; C08L 2205/035

(57) ABSTRACT

A transparent flame-retardant sheet having a high chlorine content is provided. The transparent flame-retardant sheet is made of a polyvinyl chloride composition that includes 100 parts by weight of a polyvinyl chloride raw material component, 0.1 to 1 parts by weight of at least one carbon forming agent, and 2 to 5 parts by weight of at least one heat stabilizer. The polyvinyl chloride raw material component includes a polyvinyl chloride raw material and a chlorinated polyvinyl chloride raw material in a content ratio of 1:1.22 to 1:4. Therefore, the transparent flame-retardant sheet has a fire propagation index (FPI) of less than 6 and a smoke damage index (SDI) of less than 0.4 according to the FM4910 standard under the condition of having a thickness of 5 mm.

### CROSS-REFERENCE TO RELATED PATENT APPLICATION

This application claims the benefit of priority to Taiwan Patent Application No. 113142659, filed on Nov. 7, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a plastic sheet, and more particularly to a transparent flame-retardant sheet having a high chlorine content and a polyvinyl chloride composition thereof.

### BACKGROUND OF THE DISCLOSURE

Polyvinyl chloride (PVC) has good performance in flame resistance, chemical resistance, transparency, mechanical strength, electrical insulation, and processability, and has become one of the most widely used plastic materials and can be used in the manufacture of film, sheet, pipe, and wire insulation.

However, most of the plasticizers in PVC products are flammable and can produce a large amount of smoke when PVC products burn, making escape and rescue difficult. The application scope of PVC materials in semiconductor factories and electronics factories continues to expand, such as ceilings, partition screens, and process, air flow control, and ventilation equipment of the cleanroom. If flame retardance and smoke suppression cannot be effectively performed in the event of a fire, the spread of fire and large amounts of harmful smoke may cause great losses. Therefore, how to improve the flame retardant and smoke suppression performance of PVC products has become an important issue in the related industries.

Although flame retardants and smoke inhibitors can be added to PVC materials to achieve certain flame retardant and smoke suppression effects, material processability and product mechanical properties may be negatively affected, and products cannot satisfy the high transparency requirement in practical applications.

### SUMMARY OF THE DISCLOSURE

One aspect of the present disclosure is that polyvinyl chloride (PVC) and chlorinated polyvinyl chloride (CPVC) raw materials are used in combination in a specific ratio, and at least one carbon forming agent is added to a resulting PVC/CPVC blend system to produce synergistic effects, such that a finished sheet has not only high flame retardancy and low smoke emission but also a high transmittance and a low haze.

In response to the above-referenced technical inadequacies, the present disclosure provides a transparent flame-retardant sheet having a high chlorine content and a polyvinyl chloride composition thereof.

In order to solve the above-mentioned problems, one of the technical aspects adopted by the present disclosure is to provide a polyvinyl chloride composition for manufacturing a transparent flame-retardant sheet having a high chlorine content. The polyvinyl chloride composition includes 100 parts by weight of a polyvinyl chloride raw material component, 0.1 to 1 parts by weight of at least one carbon forming agent, and 2 to 5 parts by weight of at least one heat stabilizer. The polyvinyl chloride raw material component includes a polyvinyl chloride raw material and a chlorinated polyvinyl chloride raw material in a content ratio of 1:1.22 to 1:4. The transparent flame-retardant sheet, under the condition of having a thickness of 5 mm, has a chlorine content from 52% to 60%, a transmittance of not less than 60%, and a haze of not more than 10%, and has a fire propagation index (FPI) of less than 6 and a smoke damage index (SDI) of less than 0.4 according to the FM4910 standard.

In one of the possible or preferred embodiments, the at least one carbon forming agent is selected from the group consisting of phosphate ester, a phosphazene compound, ammonium polyphosphate, melamine, dicyandiamide, hydrotalcite, and zinc oxide.

In one of the possible or preferred embodiments, the at least one carbon forming agent is the combination of the phosphate ester and the zinc oxide, and a content ratio of the phosphate ester to the zinc oxide is 1:2 to 2:1.

In one of the possible or preferred embodiments, the at least one heat stabilizer is selected from the group consisting of organotins, metallic soaps, and lead salts.

In one of the possible or preferred embodiments, the at least one heat stabilizer is the combination of butyltin mercaptide and calcium zinc stabilizer, and a content of the butyltin mercaptide is greater than a content of the calcium zinc stabilizer.

In one of the possible or preferred embodiments, the polyvinyl chloride composition further includes 2.5 to 6 parts by weight of at least one impact modifier.

In one of the possible or preferred embodiments, the at least one impact modifier is selected from the group consisting of methyl methacrylate-butadiene-styrene copolymer (MBS), an acrylate copolymer, ethylene-vinyl acetate copolymer (EVA), and styrene-ethylene-butylene-styrene copolymer (SEBS).

In one of the possible or preferred embodiments, the at least one impact modifier is the combination of the MBS and the acrylate copolymer, and a content of the MBS is greater than a content of the acrylate copolymer.

In one of the possible or preferred embodiments, the polyvinyl chloride composition further includes at least one processing aid that includes a plasticizer, a slip agent, a gelling accelerator, a colorant, an antioxidant, and/or a UV absorber.

In order to solve the above-mentioned problems, another one of the technical aspects adopted by the present disclosure is to provide a transparent flame-retardant sheet having a high chlorine content, which is made of the polyvinyl chloride composition as mentioned above. The transparent flame-retardant sheet, under the condition of having a thickness of 5 mm, has a chlorine content from 52% to 60%, a transmittance of not less than 60%, and a haze of not more than 10%, and has a fire propagation index (FPI) of less than 6 and a smoke damage index (SDI) of less than 0.4 according to the FM4910 standard.

In conclusion, the polyvinyl chloride composition provided by the present disclosure includes 100 parts by weight of a polyvinyl chloride raw material component, 0.1 to 1 parts by weight of at least one carbon forming agent, and 2 to 5 parts by weight of at least one heat stabilizer, in which the polyvinyl chloride raw material component includes a polyvinyl chloride raw material and a chlorinated polyvinyl chloride raw material in a content ratio of 1:1.22 to 1:4, such that a finished sheet has high transparency and a high chlorine content, and only requires a thickness of 5 mm to achieve flame retardant properties as well as low smoke emission, which meet the FM4910 standard. Therefore, the finished sheet can reduce losses in case of fire and is thus suitable for semiconductor factories or high-end electronics factories.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a transparent flame-retardant sheet having a high chlorine content of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a polyvinyl chloride composition, which mainly includes 100 parts by weight of a polyvinyl chloride raw material component, 0.1 to 1 parts by weight of at least one carbon forming agent, and 2 to 5 parts by weight of at least one heat stabilizer. The polyvinyl chloride composition of the present disclosure is suitable as a material for fireproof transparent sheets, and can bring not only high flame retardancy and low smoke emission but also a high transmittance and a low haze to the sheets. In practice, the sheets made of the polyvinyl chloride composition of the present disclosure can be used in the construction of a cleanroom, such as ceilings, partition screens, and process, air flow control, and ventilation equipment of the cleanroom.

### [Polyvinyl Chloride Raw Material Component]

In the polyvinyl chloride composition of the present disclosure, the polyvinyl chloride raw material component includes a polyvinyl chloride raw material (PVC) and a chlorinated polyvinyl chloride raw material (CPVC). That is, the polyvinyl chloride raw material component is a PVC/CPVC blend system. The polyvinyl chloride raw material and the chlorinated polyvinyl chloride raw material are present in the form of powders and mixed with each other at a content ratio from 1:1.22 to 1:4, and preferably from 1:1.5 to 1:3. Therefore, products such as sheets made of the polyvinyl chloride composition of the present disclosure can have a high chlorine content, so as to increase flame retardancy and allow for high transparency.

The inventor conducts a simulated fire resistance test with a flame temperature of 835° C. and a flame height of 3 cm according to the UL94-5V test on a sheet sample made of the PVC/CPVC blend system, a sheet sample made of a pure PVC system, and a sheet sample made of a pure CPVC system. The results show that the sheet sample made of the PVC/CPVC blend system has a burn-through time of greater than 650 seconds, which is better than the burn-through time of 314 seconds of the sheet sample made of the pure PVC system and the burn-through time of 211 seconds of the sheet sample made of the pure CPVC system.

In practice, the sum of the added amounts of the polyvinyl chloride raw material and the chlorinated polyvinyl chloride raw material is 100 parts by weight. The polyvinyl chloride raw material and the chlorinated polyvinyl chloride raw material can be obtained commercially or prepared by any methods known in the art or disclosed in literatures. The polyvinyl chloride raw material has an average degree of polymerization ranging from 740 to 1000 and a chlorine content ranging from 55% to 59%. The chlorinated polyvinyl chloride raw material has an average degree of polymerization ranging from 400 to 850 and a chlorine content ranging from 63% to 68%.

It should be noted that if the content of the polyvinyl chloride raw material in the polyvinyl chloride raw material component is too high, a resulting product cannot reach a required chlorine content, which would negatively affect flame retardancy. If the content of the polyvinyl chloride raw material in the polyvinyl chloride raw material component is too low, a resulting polyvinyl chloride composition would have poor processability and its product is prone to yellowing, which would produce negative effects on transmittance and haze.

In one of the possible embodiments, when the polyvinyl chloride raw material and the chlorinated polyvinyl chloride raw material are used in combination with each other at the above-mentioned content ratio, a resulting product such as a sheet can have a chlorine content ranging from 52% to 60%, preferably ranging from 54% to 59%, thereby achieving flame retardant properties that meet the FM4910 standard. In one of the preferred embodiments, the content of the chlorinated polyvinyl chloride raw material is greater than the content of the polyvinyl chloride raw material.

### [Carbon Forming Agent]

In the polyvinyl chloride composition of the present disclosure, the at least one carbon forming agent is used to accelerate the carbonization of the PVC/CPVC blend system, so that carbon particles grow quickly and have high strength during carbonization. Accordingly, when a resulting product such as a sheet is exposed to flames or high heat, a dense and solid carbon barrier layer can be formed on surfaces of the resulting product, which make the resulting product difficult to catch and spread fire and can reduce the amount of smoke produced by fire. As a result, the FM4910 certification can be passed. The at least one carbon forming agent can be one or more selected from phosphate ester, a phosphazene compound, ammonium polyphosphate, melamine, dicyandiamide, hydrotalcite, and zinc oxide to be used alone or in combination. Preferably, the content of the at least one carbon forming agent in the polyvinyl chloride composition ranges from 0.1 to 0.5 parts by weight.

It should be noted that if the content of the carbon forming agent in the polyvinyl chloride composition is too high, a resulting product would have an increase in haze and become less transparent. If the content of the carbon forming agent in the polyvinyl chloride composition is too low, a resulting product would be easily burned through due to poor carbonization or a surface carbon layer that is not dense enough, and the suppression of smoke generation is ineffective.

In one of the possible embodiments, the content of the at least one carbon forming agent in the polyvinyl chloride composition can be 0.1, 0.2, 0.3, 0.4, 0.5, 0.6, 0.7, 0.8, 0.9, or 1 part by weight per 100 parts by weight of the polyvinyl chloride raw material component. It should be noted that the carbon forming agent can produce a synergistic flame retardant effect with the polyvinyl chloride raw material component, and can thus be maintained at a low content, which is advantageous for reducing haze. Furthermore, there is no need to add other flame retardants. In one of the preferred embodiments, the at least one carbon forming agent is the combination of the phosphate ester and the zinc oxide, and a content ratio of the phosphate ester to the zinc oxide is 1:2 to 2:1.

### [Heat Stabilizer]

In the polyvinyl chloride composition of the present disclosure, the at least one heat stabilizer is used to prevent yellowing, embrittlement, and loss of physical properties due to the thermal decomposition of the polyvinyl chloride raw material component during processing. The at least one heat stabilizer can be one or more selected from organotins (e.g., thiol organotin), metallic soaps (e.g., calcium zinc stabilizer), and lead salts to be used alone or in combination.

In one of the possible embodiments, the content of the at least one heat stabilizer in the polyvinyl chloride composition can be 2, 2.5, 3, 3.5, 4, 4.5, or 5 parts by weight per 100 parts by weight of the polyvinyl chloride raw material component. In one of the preferred embodiments, the at least one heat stabilizer is the combination of butyltin mercaptide and calcium zinc stabilizer, and a content of the butyltin mercaptide is greater than a content of the calcium zinc stabilizer. It should be noted that the at least one carbon forming agent can also provide a thermal stabilization effect to have a synergistic effect with the at least one heat stabilizer, so that the at least one can be maintained at a low content.

### [Impact Modifier]

The polyvinyl chloride composition of the prevent disclosure can further include at least one impact modifier for improving the toughness and impact resistance of products such as sheets, especially at low temperatures. The at least one impact modifier can be one or more selected from methyl methacrylate-butadiene-styrene copolymer (MBS), an acrylate copolymer, ethylene-vinyl acetate copolymer (EVA), and styrene-ethylene-butylene-styrene copolymer (SEBS) to be used alone or in combination. The content of the at least one impact modifier ranges from 2.5 to 6 parts by weight per 100 parts by weight of the polyvinyl chloride raw material component.

In one of the possible embodiments, the content of the at least one impact modifier in the polyvinyl chloride composition can be 2.5, 3, 3.5, 4, 4.5, 5, 5.5, or 6 parts by weight per 100 parts by weight of the polyvinyl chloride raw material component. In one of the preferred embodiments, the at least one impact modifier is the combination of the MBS and the acrylate copolymer, and a content of the MBS is greater than a content of the acrylate copolymer.

### [Processing Aid]

The polyvinyl chloride composition of the prevent disclosure can further include at least one processing aid. The type and amount of the at least one processing aid can be adjusted according to different applications. For example, the at least one processing aid is at least one selected from a plasticizer, a slip agent, a gelling accelerator, a colorant, an antioxidant, a UV absorber, and a flow aid, and the content of the at least one processing aid in the polyvinyl chloride composition is 4 to 10 parts by weight per 100 parts by weight of the polyvinyl chloride raw material component. However, such an example is not intended to limit the scope of the present disclosure.

In one of the possible embodiments, the at least one processing aid is a combination of a plasticizer, a slip agent, a gelling accelerator, a colorant, an antioxidant, a UV absorber, and a flow aid, so as to meet the requirements of continuous production. In the polyvinyl chloride composition, the content of the plasticizer can be 0.1 to 2 parts by weight, the content of the slip agent can be 0.3 to 5 parts by weight, the content of the gelling accelerator can be 0.2 to 1 parts by weight, the content of the colorant can be 0.0001 to 0.3 parts by weight, the content of the antioxidant can be 0.5 to 1.6 parts by weight, the content of the UV absorber can be 0.4 to 1.5 parts by weight, and the content of the flow aid can be 0.5 to 5 parts by weight, relative to 100 parts by weight of the polyvinyl chloride raw material component.

### [Transparent Flame-Retardant Sheet Having High Chlorine Content]

The present disclosure further provides a transparent flame-retardant sheet having a high chlorine content, which is made of the above-mentioned polyvinyl chloride composition. The transparent flame-retardant sheet of the present disclosure has a chlorine content from 52% to 60%, a transmittance of not less than 60%, and a haze of not more than 10%, and has a fire propagation index (FPI) of less than 6 and a smoke damage index (SDI) of less than 0.4 according to the FM4910 standard under the condition of having a thickness of 5 mm.

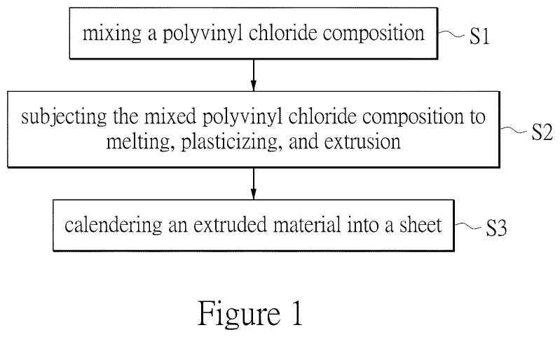

Referring to FIG. 1, the transparent flame-retardant sheet of the present disclosure can be formed by a calendering process, which includes: step S1, mixing the polyvinyl chloride composition; step S2, subjecting the mixed polyvinyl chloride composition to melting, plasticizing, and extrusion; and step S3, calendering an extruded material into a sheet.

In step S1, the polyvinyl chloride raw material component as a main component is mixed with other components including the at least one carbon forming agent, the at least one heat stabilizer, the at least one impact modifier, and the at least one processing aid according to a formula ratio. In one of possible embodiments, the main component and the other components can be mixed with each other by sequentially feeding into a hot mixer and a cold mixer.

In step S2, the mixed polyvinyl chloride composition is heated, melted, and plasticized to form a melt having a temperature from about 140° C. to about 210° C. to be extruded.

In step S3, an extruded material obtained in step S2 is fed into a calender and formed into a sheet having a predetermined thickness (e.g., 5-20 mm) through the action of heating rollers.

### Examples and Comparative Examples

In a polyvinyl chloride composition of Example 1, a content ratio of a polyvinyl chloride raw material and a chlorinated polyvinyl chloride raw material is 1:1.23, which falls within the range from 1:1.22 to 1:4, and a content of each of at least one carbon forming agent, at least one heat stabilizer, at least one impact modifier, and at least one processing aid falls within the content range disclosed in the present disclosure. More specifically, the at least one carbon forming agent of Example 1 is a composite carbon forming agent being the combination of the phosphate ester and the zinc oxide, and a content ratio of the phosphate ester to the zinc oxide falls within the content range disclosed in the present disclosure. The at least one heat stabilizer of Example 1 is a composite heat stabilizer being the combination of butyltin mercaptide and calcium zinc stabilizer, and a content of the butyltin mercaptide is greater than a content of the calcium zinc stabilizer. The at least one impact modifier of Example 1 is a composite impact modifier being the combination of the MBS and an acrylate copolymer, and a content of the MBS is greater than a content of the acrylate copolymer.

The difference between Comparative Example 1 and Example 1 is as follows: in a polyvinyl chloride composition of Comparative Example 1, a content ratio of the polyvinyl chloride raw material and the chlorinated polyvinyl chloride raw material is 1.56:1, which is outside the range from 1:1.22 to 1:4.

The difference between Comparative Example 2 and Example 1 is as follows: in a polyvinyl chloride composition of Comparative Example 2, a content ratio of the polyvinyl chloride raw material and the chlorinated polyvinyl chloride raw material is 1:4.26, which is outside the range from 1: 1.22 to 1:4.

The difference between Comparative Example 3 and Example 1 is as follows: a polyvinyl chloride composition of Comparative Example 3 does not include any carbon forming agent.

The difference between Comparative Example 4 and Example 1 is as follows: in a polyvinyl chloride composition of Comparative Example 4, a content ratio of the at least one carbon forming agent is too high.

Sheet samples having a thickness of 5 mm, which are made of the polyvinyl chloride compositions of Example 1 and Comparative Examples 1-4 by step S1 to step S3 as shown in FIG. 1, are tested for flame retardant performance and optical properties. Test methods are described as follows, and test results are shown in Table 1 and Table 2.

Fire propagation index (FPI): exposing a sheet sample to be tested to an ignition energy and measuring an index in relation to the propensity of the sheet sample to support fire propagation according to the FM4910 standard.

Smoke damage index (SDI): exposing a sheet sample to be tested to an ignition energy and measuring an index in relation to the propensity of the sheet sample to generate smoke according to the FM4910 standard.

Transmittance (%): testing a sheet sample to be tested for a total light transmittance according to ASTM D1003 standard, which is taken as the transmittance of the sheet sample.

Haze (%): testing a sheet sample to be tested for a diffusion transmittance and a total light transmittance according to ASTM D1003 standard, in which a ratio of the diffusion transmittance to the total light transmittance is taken as the haze of the sheet sample.

TABLE 1

| | | Exam- | Comparative | Comparative |
|---|---|---|---|---|
| Unit: parts by weight (phr) | | ple 1 | Example 1 | Example 2 |
| Polyvinyl | PVC powder | 30 | 30 | 30 |
| chloride raw | CPVC powder | 70 | 70 | 70 |
| material | | | | |
| component | | | | |
| Carbon | Phosphate ester | 0.2 | 0.2 | 0.2 |
| forming | Zinc oxide | 0.3 | 0.3 | 0.3 |
| agent | | | | |
| Heat | Butyltin mercaptide | 3 | 3 | 3 |
| stabilizer | Calcium zinc | 0.5 | 0.5 | 0.5 |
| | stabilizer | | | |
| Impact | MBS | 2 | 2 | 2 |
| modifier | Acrylate copolymer | 1.5 | 1.5 | 1.5 |
| Processing | Plasticizer | 1.5 | 1.5 | 1.5 |
| aid | Slip agent | 3 | 3 | 3 |
| | Gelling accelerator | 0.5 | 0.5 | 0.5 |
| | Colorant | 0.0003 | 0.0003 | 0.0003 |
| | Antioxidant | 0.5 | 0.5 | 0.5 |
| | UV absorber | 0.4 | 0.4 | 0.4 |
| Chlorine | (%) | 57.4 | 51.2 | 60.1 |
| content | | | | |
| Optical | Transmittance (%) | 66.4 | 72.4 | 59.7 |
| properties | Haze (%) | 8.7 | 7.2 | 21.9 |
| Flame | Fire propagation | 5.6 | 6.5 | 5.2 |
| retardant | index (FPI) | | | |
| performance | Smoke damage | 0.13 | 0.14 | 0.11 |
| | index (SDI) | | | |

TABLE 2

| | | Exam- | Comparative | Comparative |
|---|---|---|---|---|
| Unit: parts by weight (phr) | | ple 1 | Example 3 | Example 4 |
| Polyvinyl | PVC powder | 30 | 30 | 30 |
| chloride raw | CPVC powder | 70 | 70 | 70 |
| material | | | | |
| component | | | | |
| Carbon | Phosphate ester | 0.2 | | 0.5 |
| forming | Zinc oxide | 0.3 | | 0.6 |
| agent | | | | |
| Heat | Butyltin mercaptide | 3 | 3 | 3 |
| stabilizer | Calcium zinc | 0.5 | 0.5 | 0.5 |
| | stabilizer | | | |
| Impact | MBS | 2 | 2 | 2 |
| modifier | Acrylate copolymer | 1.5 | 1.5 | 1.5 |
| Processing | Plasticizer | 1.5 | 1.5 | 1.5 |
| aid | Slip agent | 3 | 3 | 3 |
| | Gelling accelerator | 0.5 | 0.5 | 0.5 |
| | Colorant | 0.0003 | 0.0003 | 0.0003 |
| | Antioxidant | 0.5 | 0.5 | 0.5 |
| | UV absorber | 0.4 | 0.4 | 0.4 |
| Chlorine | (%) | 57.4 | 57.6 | 57.1 |
| content | | | | |
| Optical | Transmittance (%) | 66.4 | 68.4 | 54.3 |
| properties | Haze (%) | 8.7 | 7.9 | 31.2 |
| Flame | Fire propagation | 5.6 | 6.1 | 5.4 |
| retardant | index (FPI) | | | |
| performance | Smoke damage | 0.13 | 4.7 | 0.11 |
| | index (SDI) | | | |

It can be seen from the comparison between Example 1 and Comparative Examples 1 and 2 that, when a content ratio of the polyvinyl chloride raw material and the chlorinated polyvinyl chloride raw material in the polyvinyl chloride raw material falls within the range from 1:1.22 to 1:4 disclosed in the present disclosure, a resulting sheet can have a sufficient chlorine content so as to achieve flame retardant performance (i.e., ability to suppress the spread of flames) that meet the FM4910 standard. If the content of the polyvinyl chloride raw material is too high, a resulting sheet cannot achieve a FPI of less than 6. If the content of the chlorinated polyvinyl chloride raw material is too high, although a resulting sheet can achieve a FPI of less than 6, the resulting sheet would have an increase in haze and become less transparent.

It can be seen from the comparison between Example 1 and Comparative Examples 3 and 4 that, the addition of the at least one carbon forming agent can effectively reduce the generation of toxic smoke so as to achieve a SDI of less than 0.4. Furthermore, the content of the at least one carbon forming agent in the polyvinyl chloride composition should not be too high, otherwise it will significantly increase the haze of the sheet and result in poor optical transparency.

### Beneficial Effects of the Embodiments

The polyvinyl chloride composition provided by the present disclosure includes 100 parts by weight of a polyvinyl chloride raw material component, 0.1 to 1 parts by weight of at least one carbon forming agent, and 2 to 5 parts by weight of at least one heat stabilizer, in which the polyvinyl chloride raw material component includes a polyvinyl chloride raw material and a chlorinated polyvinyl chloride raw material in a content ratio of 1:1.22 to 1:4, such that a finished sheet has high transparency and a high chlorine content, and only requires a thickness of 5 mm to achieve flame retardant properties as well as low smoke emission, which meet the FM4910 standard. Therefore, the finished sheet can reduce losses in case of fire and is thus suitable for semiconductor factories or high-end electronics factories.

The inventor conducts a simulated fire resistance test with a flame temperature of 835° C. and a flame height of 3 cm according to the UL94-5V test on a sheet sample made of the PVC/CPVC blend system, a sheet sample made of a pure PVC system, and a sheet sample made of a pure CPVC system. The results show that the sheet sample made of the PVC/CPVC blend system has a burn-through time of greater than 650 seconds, which is better than the burn-through time of 314 seconds of the sheet sample made of the pure PVC system and the burn-through time of 211 seconds of the sheet sample made of the pure CPVC system.

More specifically, the carbon forming agent can produce a synergistic flame retardant effect with the polyvinyl chloride raw material component, and can thus be maintained at a low content, which is advantageous for reducing haze. Furthermore, there is no need to add other flame retardants.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyvinyl chloride composition for manufacturing a transparent flame-retardant sheet having a high chlorine content, comprising:
100 parts by weight of a polyvinyl chloride raw material component including a polyvinyl chloride raw material and a chlorinated polyvinyl chloride raw material in a content ratio of 1:1.22 to 1:4;
0.1 to 1 parts by weight of at least one carbon forming agent; and
2 to 5 parts by weight of at least one heat stabilizer;
wherein the transparent flame-retardant sheet, under the condition of having a thickness of 5 mm, has a chlorine content from 52% to 60%, a transmittance of not less than 60%, and a haze of not more than 10%, and has a fire propagation index (FPI) of less than 6 and a smoke damage index (SDI) of less than 0.4 according to the FM4910 standard.

2. The polyvinyl chloride composition according to claim 1, wherein the at least one carbon forming agent is selected from the group consisting of phosphate ester, a phosphazene compound, ammonium polyphosphate, melamine, dicyandiamide, hydrotalcite, and zinc oxide.

3. The polyvinyl chloride composition according to claim 2, wherein the at least one carbon forming agent is the combination of the phosphate ester and the zinc oxide, and a content ratio of the phosphate ester to the zinc oxide is 1:2 to 2:1.

4. The polyvinyl chloride composition according to claim 1, wherein the at least one heat stabilizer is selected from the group consisting of organotins, metallic soaps, and lead salts.

5. The polyvinyl chloride composition according to claim 4, wherein the at least one heat stabilizer is the combination of butyltin mercaptide and calcium zinc stabilizer, and a content of the butyltin mercaptide is greater than a content of the calcium zinc stabilizer.

6. The polyvinyl chloride composition according to claim 1, further comprising 2.5 to 6 parts by weight of at least one impact modifier.

7. The polyvinyl chloride composition according to claim 1, wherein the at least one impact modifier is selected from the group consisting of methyl methacrylate-butadiene-styrene copolymer (MBS), an acrylate copolymer, ethylene-vinyl acetate copolymer (EVA), and styrene-ethylene-butylene-styrene copolymer (SEBS).

8. The polyvinyl chloride composition according to claim 7, wherein the at least one impact modifier is the combination of the MBS and the acrylate copolymer, and a content of the MBS is greater than a content of the acrylate copolymer.

9. The polyvinyl chloride composition according to claim 1, further comprising at least one processing aid that includes a plasticizer, a slip agent, a gelling accelerator, a colorant, an antioxidant, and/or a UV absorber.

10. A transparent flame-retardant sheet having a high chlorine content made of the polyvinyl chloride composition as claimed in claim 1, wherein the transparent flame-retardant sheet has a chlorine content from 52% to 60%, a transmittance of not less than 60%, and a haze of not more than 10%, and has a fire propagation index (FPI) of less than 6 and a smoke damage index (SDI) of less than 0.4 according to the FM4910 standard under the condition of having a thickness of 5 mm.
